(19) United States
(12) Patent Application Publication
(10) Pub. No.: US 2025/0301236 A1
(43) Pub. Date: Sep. 25, 2025

(54) APPARATUS AND METHOD

(71) Applicant: CANON KABUSHIKI KAISHA, Tokyo (JP)

(72) Inventor: TOSHIYUKI OKUBO, Tokyo (JP)

(21) Appl. No.: 19/085,931

(22) Filed: Mar. 20, 2025

(30) Foreign Application Priority Data
Mar. 25, 2024 (JP) 2024-048763

(51) Int. Cl. H04N 25/53

(52) U.S. Cl. CPC H04N 25/53

(57) ABSTRACT

A device capable of controlling intermittent charge accumulation and a setting unit that sets shutter speed and an amount of an electronic neutral density (ND) effect are included. A pattern is set so that, at the time of intermittent charge accumulation, time from start of charge accumulation to end of the charge accumulation falls within a predetermined range with respect to a set exposure period.

### BACKGROUND

### Technical Field

The aspect of the embodiments relates to an apparatus and a method.

### Description of the Related Art

In late years, imaging apparatuses such as a home-video camera and a digital still camera have come into widespread use. These imaging apparatuses are equipped with an electronic shutter image capturing function that allows for continuous image capturing with less operating noise at higher speed than mechanical shutter imaging.

According to a global shutter method for the electronic shutter image capturing function, it is possible to execute the start/end of charge accumulation collectively on a screen, and perform image capturing without generation of so-called rolling shutter distortion. Additionally, as discussed in Japanese Patent Application Laid-Open No. 2015-109503, performing intermittent charge accumulation makes it possible to implement an electronic neutral density (ND) function that reduces a quantity of incident light in a set exposure period more than usual to perform image capturing.

However, according to a method discussed in Japanese Patent Application Laid-Open No. 2015-109503, in a case where image capturing is performed with incident light that is reduced in quantity by intermittent charge accumulation in a charge accumulation period set by a user, there is a possibility that image capturing is performed in an exposure period that is different from an exposure period that is intended by the user. In this case, captured is an image that is different from a captured image that is supposed to be acquired.

### SUMMARY

According to an aspect of the embodiments, an apparatus includes an element configured to convert an image into an electric signal, a setting part configured to set an exposure period of the element, and a controller configured to determine, when the element performs intermittent charge accumulation to obtain a dimming effect, a pattern with respect to a start timing and end timing of the set exposure period so that a start timing of first charge accumulation and an end timing of last charge accumulation fall within a predetermined range.

Further features of the disclosure will become apparent from the following description of exemplary embodiments with reference to the attached drawings.

### BRIEF DESCRIPTION OF THE DRAWINGS

FIG. 1 is a block diagram illustrating an imaging apparatus according to an exemplary embodiment.

FIG. 2 is a circuit diagram illustrating part of an image pickup device according to the present exemplary embodiment.

FIGS. 3A and 3B are diagrams each illustrating a pattern of intermittent charge accumulation according to the present exemplary embodiment.

FIG. 4 is a diagram illustrating a permissible range of an error in accumulation time of intermittent charge accumulation according to the present exemplary embodiment.

FIG. 5 is a diagram illustrating image capturing cycle synchronization in intermittent charge accumulation according to the exemplary embodiment.

FIG. 6 is a diagram illustrating gain compensation by image capturing cycle synchronization in intermittent charge accumulation according to the exemplary embodiment.

FIGS. 7A and 7B are views each illustrating a setting screen for an electronic neutral density (ND) function according to the exemplary embodiment.

### DESCRIPTION OF THE EMBODIMENTS

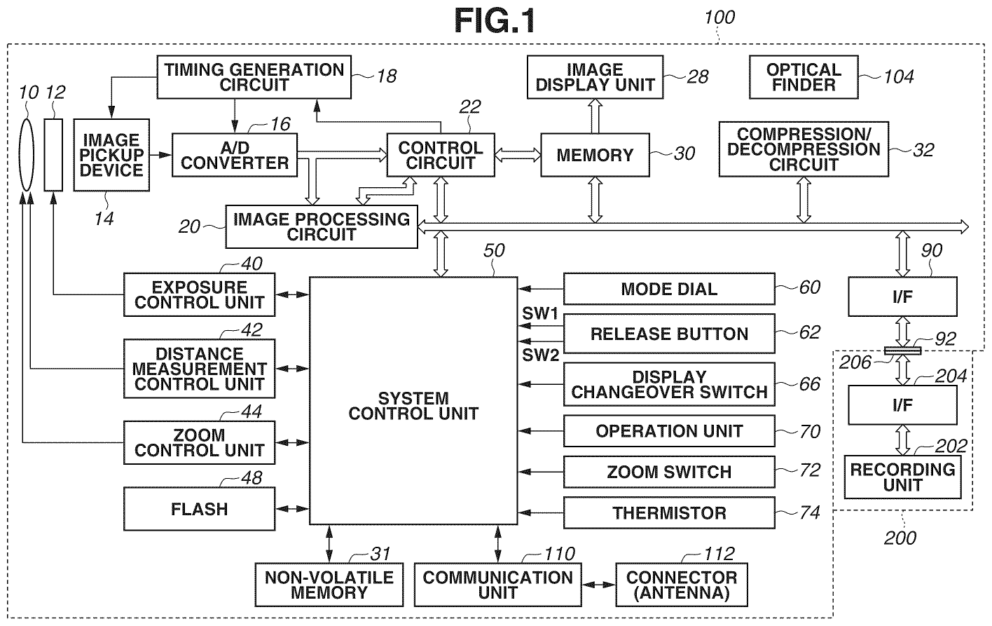

An exemplary embodiment of the present invention will be described in detail below with reference to the accompanying drawings. FIG. 1 is a block diagram illustrating a schematic configuration of an imaging apparatus 100 in the present exemplary embodiment of the present invention.

In FIG. 1, an imaging lens 10 forms an optical image on an image pickup device 14. A mechanical shutter 12 has an aperture function, and is capable of adjusting a light quantity of an optical image that has reached the image pickup device 14. The image pickup device 14 converts the optical image into an electric signal, and an analog/digital (A/D) converter 16 converts an analog signal output from the image pickup device 14 into a digital signal. The A/D converter 16 may be built into the image pickup device 14.

A timing generation circuit 18 is controlled by a control circuit 22 and a system control circuit 50, and supplies a clock signal or a control signal to the image pickup device 14 and the A/D converter 16. In moving-image capturing or the like, charge accumulation time can be controlled by, other than the mechanical shutter 12, an electronic shutter that controls a reset timing of the image pickup device 14.

An image processing circuit 20 performs predetermined pixel interpolation processing or color conversion processing on image data that is supplied from the A/D converter 16 or the control circuit 22. Additionally, the image processing circuit 20 performs segmentation of an image or scaling processing, and thereby implements an electronic zoom function. Furthermore, the image processing circuit 20 performs automatic white balance (AWB) processing according to a through the lens (TTL) method using a calculation result obtained by performing predetermined calculation processing on captured image data.

Image data output from the A/D converter 16 is written to a memory 30 via the image processing circuit 20 and the control circuit 22. The image data for display that is written to the memory 30 is supplied to and displayed on an image display unit 28 via the control circuit 22. The image display unit 28 includes a thin-film transistor (TFT) and a liquid crystal display (LCD). Sequentially displaying captured image data on the image display unit 28 makes it possible to implement an electronic finder function. The image display unit 28 is capable of freely turning ON/OFF a display in response to an instruction from the system control circuit 50. In a case where the image display unit 28 turns OFF the display, it is possible to significantly reduce power consumption of the imaging apparatus 100.

The memory 30 can also be used as a work region of the system control circuit 50. Program codes executed by the system control circuit 50 are written to a non-volatile memory 31 including a flash read-only memory (ROM). The system control circuit 50 executes the program codes while sequentially reading out the program codes.

Additionally, a region that stores system information and a region that stores user setting information are provided in the non-volatile memory 31. Various kinds of information and various kinds of settings are read out at the next time of start-up and can thereby be decompressed. The system control circuit 50 executes the program codes written to the non-volatile memory 31 while sequentially reading out the program codes, and thereby controls the whole operation of the imaging apparatus 100.

A compression/decompression circuit 32 reads out image data stored in the memory 30, performs adaptive discrete cosine transform (ADCT) or the like to perform compression processing or decompression processing, and writes the processed image data to the memory 30 again.

The system control circuit 50 controls the image processing circuit 20 to perform predetermined calculation processing on captured image data acquired according to the TTL method. The system control circuit 50 uses the acquired calculation result to control an exposure control unit 40 and a distance measurement control unit 42 to perform automatic exposure (AE) processing and autofocus (AF) processing, respectively.

The exposure control unit 40 controls an aperture function of the mechanical shutter 12 based on the result of calculation performed by the image processing circuit 20 to adjust a quantity of light incident on (exposure of) the image pickup device 14. Additionally, the exposure control unit 40 also controls a flash modulation function in conjunction with a flash 48.

The distance measurement control unit 42 performs focus control with the imaging lens 10 based on the image data acquired according to the TTL method. In a case where a quantity of light is insufficient at the time of focus control, the flash 48 is caused to emit light as AF assist light.

A zoom control unit 44 controls optical zooming with the imaging lens 10.

With a mode dial 60, it is possible to make settings by switching power-ON/OFF of the imaging apparatus 100 in response to the user's operation, various kinds of image capturing modes (automatic image capturing, panoramic image capturing, moving image capturing, and the like), and various kinds of function modes (playback, personal computer (PC) connection, and the like).

When a release button 62 is brought into a half-pressed state by the user's operation, a first switch SW1 is turned ON. When the first switch SW1 is turned ON, the system control circuit 50 starts an image capturing preparation operation such as AF processing, AE processing, and AWB processing. When the release button 62 is brought into a fully-pressed state, a second switch SW2 is turned ON, and a sequence of image capturing operation is performed.

In response to an instruction for starting the image capturing, the image pickup device 14 is exposed to light during exposure time determined in the AE processing. In a case of flash image capturing, a light emission quantity is determined by flash preliminary emission processing and flash light is emitted during exposure of the image pickup device 14. When exposure ends, captured image data subjected to development processing in the image processing circuit 20 and compression processing in the compression/decompression circuit 32 is stored in a recording medium 200.

With a display changeover switch 66, it is possible to give an instruction to switch the display of the image display unit 28 in response to the user's operation. For example, in a case where the image capturing is performed with use of an optical finder 104, it is possible to cut supply of current to the image display unit 28 composed of a thin-film transistor (TFT), a liquid crystal display (LCD), and the like to reduce power consumption.

An operation unit 70 is a unit for setting various kinds of functions of the imaging apparatus 100 in response to the user's operation. For example, the operation unit 70 includes a display menu button, a set button, a macro button, a multi-screen reproduction page-break button, a flash setting button, and a single photographing/continuous photographing/self-timer set button. Additionally, the operation unit 70 may include a menu scroll +/− (plus/minus) button, a playback image scroll +/− (plus/minus) button, a captured image quality selection button, an exposure correction button, and a date/time setting button.

A zoom switch 72 is a switch for giving an instruction to change a magnification ratio of a captured image in response to the user's operation, and is composed of a telephoto switch that changes an imaging angle of view to a telephoto direction, and a wide switch that changes the imaging angle to a wide-angle direction. Operating the zoom switch 72 makes it possible for the zoom control unit 44 to perform an optical zoom operation of the imaging lens 10. Additionally, operating the zoom switch 72 makes it possible for the image processing circuit 20 to also perform segmentation processing on a captured image, and pixel interpolation processing to perform electronic zooming processing with the imaging angle of view.

Each of these operation units may be composed of various kinds of buttons, a switch, a rotary dial, a touch panel, a pointing device that performs line-of-sight detection or the like, a voice recognition device, and the like in isolation or in combination.

A thermistor 74 is a device that measures a temperature of the inside of the imaging apparatus 100. The thermistor 74 is disposed near the image pickup device 14, and thereby capable of measuring a temperature of the image pickup device 14. Since a defective pixel of image data output from the image pickup device 14 is influenced by a temperature, it is possible to perform defective pixel correction processing depending on a temperature at the time of image capturing.

A communication unit 110 is used to perform various kinds of communication such as universal serial bus (USB) communication, the Institute of Electrical and Electronics Engineers (IEEE) 1394 communication, local area network (LAN) communication, and wireless communication. Providing an antenna in substitution for a connector 112 makes it possible to connect the imaging apparatus 100 to another apparatus through wireless communication.

The optical finder 104 is used for optical observation of a subject image and image capturing without use of the electronic finder function of the image display unit 28.

An interface 90 and a connector 92 are electrically connected to an interface 204 and a connector 206, respectively, in the recording medium 200 such as a memory card or a hard disk, and perform communication. The recording medium 200 includes a recording unit 202 composed of a semiconductor memory, a magnetic disk, and the like.

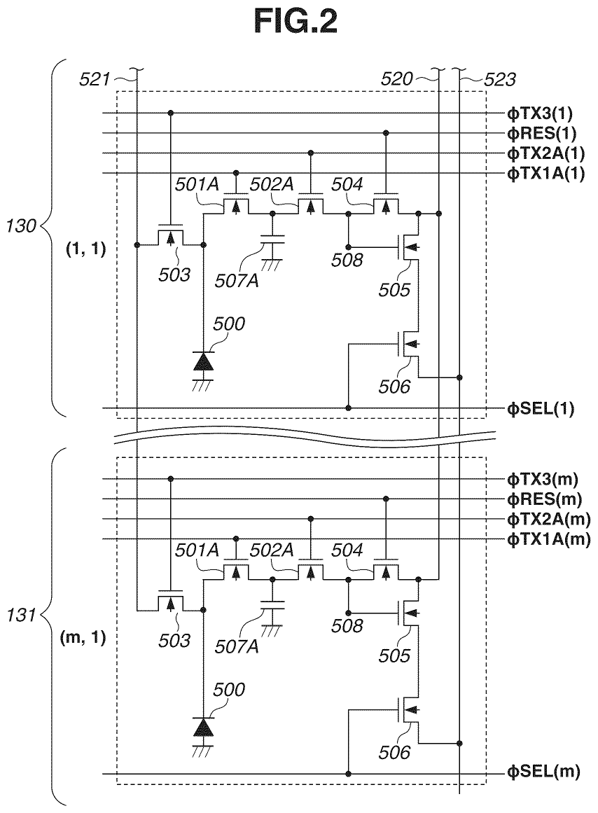

FIG. 2 is an equivalent circuit diagram illustrating part of the image pickup device 14. Multitudes of pixels are disposed in a matrix on the image pickup device 14. FIG. 2 illustrates, among the pixels, a pixel 130 on a first row and a first column (1, 1) and a pixel 131 on a freely-selected m-th row and the first column (m, 1). Since a configuration of the pixel 130 and that of the pixel 131 are similar, an identical constituent element is denoted by an identical reference number.

In the pixels 130 and 131, when light is incident on a photodiode (PD) 500 as a photoelectric conversion unit, a signal charge according to a quantity of incident light is generated. The signal charge generated in the PD 500 is transferred to and held by a charge holding unit 507A by turning-ON of a first transfer transistor 501A with a transfer pulse φTX1A.

Furthermore, by turning-ON of a second transfer transistor 502A with a transfer pulse φTX2A, the signal charge held by the charge holding unit 507A is transferred to a floating diffusion region (FD) 508. Then, by turning ON of a selection transistor 506 with a selection pulse φSEL, conversion into a voltage signal according to a quantity of the signal charge transferred to the FD 508 is performed by an amplification transistor 505, and the voltage signal is output to a signal output line 523.

Thereafter, by turning-ON of a third transfer transistor 503 with a transfer pulse φTX3, the PD 500 is connected to a power supply line 521, and a residual charge is discharged. By turning-ON of a reset transistor 504 and the second transfer transistor 502A with a reset pulse φRES and a transfer pulse φTX2A, respectively, the FD 508 and the charge holding unit 507A are connected to a power supply line 520, and a residual charge is discharged. Each control pulse is transmitted from a vertical scanning circuit, which is not illustrated.

The imaging apparatus 100 in the present exemplary embodiment has an “electronic neutral density (ND) function” for controlling a timing of charge accumulation in the image pickup device 14 to acquire an image signal that is identical to that in a case where light incident on the image pickup device 14 is dimmed. That is, the imaging apparatus 100 intermittently performs charge accumulation multiple times in an exposure period in one frame to collectively read out image signals acquired by multiple charge accumulations, and can thereby obtain an effect that is substantially identical to an effect of dimming incident light.

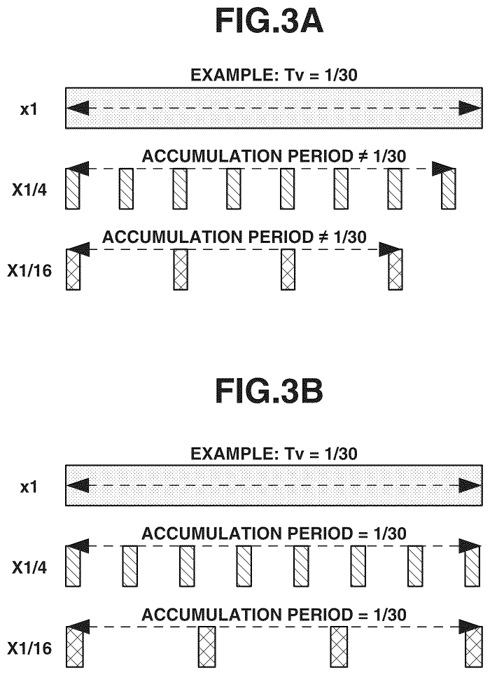

FIGS. 3A and 3B are diagrams each illustrating a charge accumulation pattern when the electronic ND function is implemented with use of the image pickup device 14. FIGS. 3A and 3B each illustrate an example in which an exposure period Tv in one frame is 1/30 seconds, and charge accumulation is intermittently performed based on the exposure period of 1/30 seconds serving as a reference, whereby charge accumulation time is reduced to one-fourth and one-sixteenth of the exposure period.

If an intermittent charge accumulation pattern is determined based on a simple duty ratio, there is a case where the last charge accumulation period in one frame ends before the elapse of 1/30 seconds as illustrated in FIG. 3A. Especially in a case where the charge accumulation period is reduced to one-sixteenth, there occurs a more significant shift in an end timing of the charge accumulation period. To address this, as illustrated in FIG. 3B, the intermittent charge accumulation pattern is determined to be matched with the exposure period of 1/30 serving as the reference. With this configuration, it is possible to make the end timing of the last charge accumulation period in one frame approximately identical to a timing at which the exposure period of 1/30 seconds elapses.

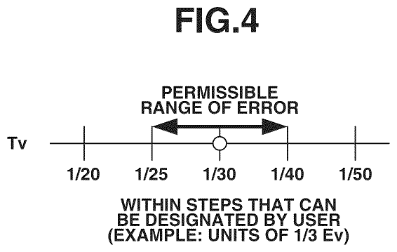

FIG. 4 is a diagram illustrating a permissible range of an error between the end timing of the last charge accumulation period in one frame and the timing at which the exposure period of 1/30 seconds elapses in a case where intermittent charge accumulation is performed. FIG. 4 illustrates an example in which the exposure period Tv in one frame is 1/30 seconds, and the charge accumulation time can be set on units of ⅓ Ev by the user.

In this case, the charge accumulation period can be set at 1/20 seconds, 1/25 seconds, 1/30 seconds, 1/40 seconds, and 1/50 seconds on a stepwise manner. In a case where the exposure period in one frame is set at 1/30 seconds to reduce the shift from the timing at which the exposure period in one frame elapses, the intermittent charge accumulation pattern is determined so that the end timing of the last charge accumulation period in one frame falls within a predetermined range. That is, the intermittent charge accumulation pattern is determined so that the end timing of the last charge accumulation period in one frame falls within a range from a timing at which 1/25 seconds elapses to a timing at which 1/40 seconds elapses.

In a case where a setting unit of the charge accumulation period, which is set by the user, is ½ Ev, the intermittent charge accumulation pattern is determined so that a shift between the end timing of the last charge accumulation period in one frame and the timing at which the exposure period in one frame elapses falls within a range of ½ Ev. Additionally, in a case where the setting unit of the charge accumulation period, which is set by the user, is 1 Ev, the intermittent charge accumulation pattern is determined so that a shift between the end timing of the last charge accumulation period in one frame and the timing at which the exposure period in one frame elapses falls within a range of 1 Ev.

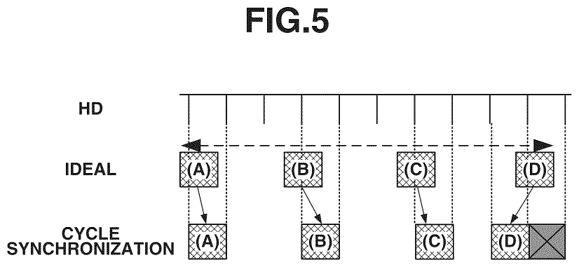

FIG. 5 is a diagram illustrating an example in which the intermittent charge accumulation is synchronized with a horizontal synchronization signal HD. FIG. 5 illustrates a charge accumulation period in which a period indicated by an arrow provided with a description of “IDEAL” is set. It is ideal that, at the time of the intermittent charge accumulation, the charge accumulation start at a start timing of the exposure period and the charge accumulation end at the end timing of the exposure period. However, it is necessary to control the charge accumulation in the image pickup device 14 to be synchronized with the horizontal synchronization signal HD for controlling the image capturing operation.

Hence, in the present embodiment, determined is an intermittent charge accumulation pattern as indicated by “CYCLE SYNCHRONIZATION” so that a timing of intermittent charge accumulation is shifted in synchronization with a timing of generating the horizontal synchronization signal HD that is close to the ideal charge accumulation period. In this processing, intermittent charge accumulation is performed in four batches in charge accumulation periods (A) to (D).

Since the ideal charge accumulation period (A) is slightly shifted from the generation timing of the horizontal synchronization signal HD, the timing of intermittent charge accumulation is shifted to a position of the charge accumulation period (A) indicated by “CYCLE SYNCHRONIZATION”.

Additionally, to synchronize the ideal charge accumulation periods (B) and (C) with the respective generation timings of the closest horizontal synchronization signals HD, the timings of intermittent charge accumulation are shifted to respective positions of the charge accumulation periods (B) and (C) indicated by “CYCLE SYNCHRONIZATION”.

Regarding the ideal charge accumulation period (D), if the timing of intermittent charge accumulation is synchronized with the generation timing of the closest horizontal synchronization signal HD, the charge accumulation period ends after the end timing of the set exposure period. This results in a large shift in time. To address this, by synchronizing the timing of intermittent charge accumulation with the generation timing of a preceding horizontal synchronization signal HD, it is possible to end the charge accumulation within the set exposure period.

In the present exemplary embodiment, the description has been given of the example of, in a case of performing intermittent charge accumulation, performing control to synchronize the timing of intermittent charge accumulation with the generation timing of the horizontal synchronization signal HD that is the closest to each ideal charge accumulation period and cause the timing of intermittent charge accumulation to infallibly fall within the set exposure period. The control is not limited thereto, and may be performed so that, for example, the set exposure period falls within a period from a start timing of the first intermittent charge accumulation period to an end timing of the last intermittent charge accumulation period.

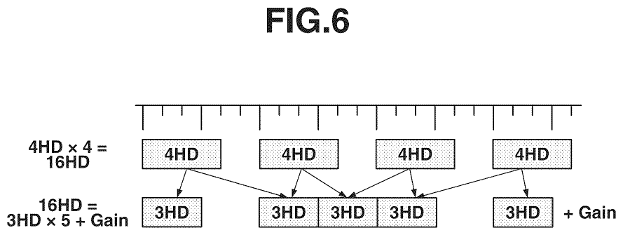

FIG. 6 is a diagram illustrating an example in which the intermittent charge accumulation is synchronized with the horizontal synchronization signal HD and gain compensation is performed.

A description is given of a case where it is necessary to perform, at the time of intermittent charge accumulation, not only charge accumulation in synchronization with the horizontal synchronization signal HD, but also perform control to make the charge accumulation period an integer multiple of a cycle of the horizontal synchronization signal HD. When control is performed to make the charge accumulation period an integer multiple of the cycle of the horizontal synchronization signal HD, there is a case where a period obtained by adding up of each charge accumulation period for intermittent charge accumulation is shorter than a charge accumulation period for obtaining a desired dimming effect with respect to the set exposure period. In this case, a shortfall of the charge accumulation period is compensated by signal amplification.

In the present exemplary embodiment, a description will be given of a case where it is necessary to set, at the time of intermittent charge accumulation, each charge accumulation period at a multiple of 3 with respect to the cycle of the horizontal synchronization signal HD. Assume that, to perform intermittent charge accumulation four times in synchronization with the horizontal synchronization signal HD to obtain a desired dimming effect, it is necessary to perform intermittent charge accumulation four times during a period that is four times the cycle of the horizontal synchronization signal HD (4HD).

In this example, it is necessary to set each charge accumulation period at a multiple of 3 with respect to the cycle of the horizontal synchronization signal HD.

However, to perform intermittent charge accumulation in a charge accumulation period that is equal to a 4HD×4=16HD period, it is sufficient that charge accumulation is performed for a period three times the cycle of the horizontal synchronization signal HD (3HD period) five times. However, in this 3HD×5=15HD period, there is a shortage of signals corresponding to charge accumulation in a 1HD period. To address this, in the present exemplary embodiment, control is performed to compensate deficient signals for 1HD by amplification. Gain necessary for compensating signals for 1HD is expressed as gain=16HD/15HD=1.067 times. Thus, it is possible to acquire image signals with a desired dimming effect by applying gain with an amplification circuit built into the image pickup device 14 or the image processing circuit 20 to perform signal amplification.

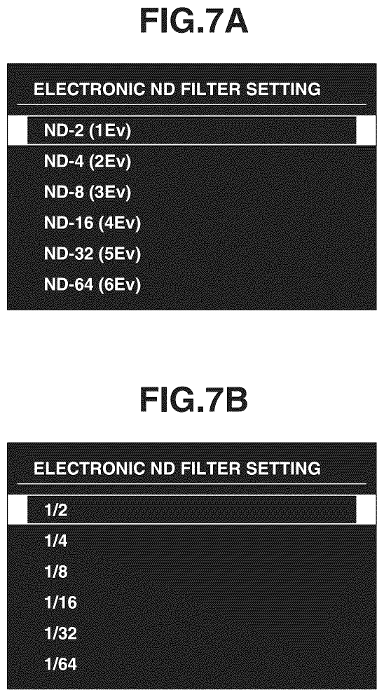

FIGS. 7A and 7B are views each illustrating a setting screen for the user to set a quantity of dimming regarding the electronic ND function.

In the electronic ND function, it is necessary to set the number of steps regarding a quantity of dimming depending on a situation where the user performs image capturing. In FIG. 7A, display that is uniformized in notation of a general optical ND filter is performed. Additionally, in FIG. 7B, the display is expressed in notion of a quantity of dimming of the electronic ND filter using the number of steps. It is possible to determine an intermittent charge accumulation pattern based on setting values on these setting screens and execute image capturing using the electronic ND function.

As described above, it is possible to perform image capturing based on the desired dimming effect in the set exposure period.

While the detailed description has been given of the present invention based on preferred exemplary embodiments, the present invention is not limited to these specific exemplary embodiments, and includes various modes without departing from the gist of the present invention. Furthermore, each of the above-mentioned exemplary embodiments merely represents one exemplary embodiment of the present invention, and the exemplary embodiments can be combined as appropriate.

For example, in the above-mentioned exemplary embodiment, the description has been given of the imaging apparatus 100 that includes the imaging lens 10, the image pickup device 14, the system control circuit 50, and the image display unit 28, but the present invention is not limited to such a configuration. For example, the present invention can also be implemented by an imaging system in which an imaging unit (the imaging lens 10 and the image pickup device 14), the system control circuit 50, and a display apparatus are configured as individual bodies, and are communicably connected with one another.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-048763, filed Mar. 25, 2024, which is hereby incorporated by reference herein in its entirety.

What is claimed is:

1. An apparatus comprising:
an element configured to convert an image into an electric signal;
a setting part configured to set an exposure period of the element; and
a controller configured to determine, when the element performs intermittent charge accumulation to obtain a dimming effect, a pattern with respect to a start timing and end timing of the set exposure period so that a start timing of first charge accumulation and an end timing of last charge accumulation fall within a predetermined range.

2. The apparatus according to claim 1, wherein the predetermined range is a range in which a shift between the end timing of a last charge accumulation period in one frame and a timing at which the exposure period in one frame elapses is within a range of a setting part of a charge accumulation period, the setting part being set by a user.

3. The apparatus according to claim 1, wherein the controller is configured to execute each charge accumulation in synchronization with a synchronization signal when the element performs the intermittent charge accumulation.

4. The apparatus according to claim 2, wherein the controller is configured to execute each charge accumulation in synchronization with a synchronization signal when the element performs the intermittent charge accumulation.

5. The apparatus according to claim 3, wherein the controller is configured to perform control so that, when the element performs the intermittent charge accumulation, a charge accumulation period of each charge accumulation is an integer multiple of a cycle of the synchronization signal.

6. The apparatus according to claim 4, wherein the controller is configured to perform control so that, when the element performs the intermittent charge accumulation, a charge accumulation period of each charge accumulation is an integer multiple of a cycle of the synchronization signal.

7. The apparatus according to claim 5, wherein the controller is configured to, in a case where a period obtained by adding up of each period when the element performs the intermittent charge accumulation is shorter than the charge accumulation period to obtain a desired dimming effect, perform control to perform signal amplification to compensate a shortfall of the period.

8. The apparatus according to claim 6, wherein the controller is configured to, in a case where a period obtained by adding up of each period when the element performs the intermittent charge accumulation is shorter than the charge accumulation period to obtain a desired dimming effect, perform control to perform signal amplification to compensate a shortfall of the period.

9. The apparatus according to claim 1, wherein the controller is configured to determine the pattern depending on a quantity of dimming set by a user.

10. The apparatus according to claim 2, wherein the controller is configured to determine the pattern depending on a quantity of dimming set by a user.

11. The apparatus according to claim 10, wherein the controller is configured to execute each charge accumulation in synchronization with a synchronization signal when the element performs the intermittent charge accumulation.

12. The apparatus according to claim 3, wherein the controller is configured to determine the pattern depending on a quantity of dimming set by a user.

13. A method comprising:
converting an image into an electric signal;
setting an exposure period of the element; and
determining, when the element performs intermittent charge accumulation to obtain a dimming effect, a pattern with respect to a start timing and end timing of the set exposure period so that a start timing of first charge accumulation and an end timing of last charge accumulation fall within a predetermined range.

14. The method according to claim 13, wherein the predetermined range is a range in which a shift between the end timing of a last charge accumulation period in one frame and a timing at which the exposure period in one frame elapses is within a range of a setting part of a charge accumulation period, the setting part being set by a user.

15. The method according to claim 13, further comprising executing each charge accumulation in synchronization with a synchronization signal when the element performs the intermittent charge accumulation.

16. The method according to claim 13, further comprising determining the pattern depending on a quantity of dimming set by a user.
